(19) United States
(12) Patent Application Publication
(10) Pub. No.: US 2005/0187309 A1
(43) Pub. Date: Aug. 25, 2005

(54) Inkjet recording ink

(75) Inventor: Shinya Watanabe, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: KONICA MINOLTA MEDICAL & GRAPHIC, INC., Tokyo (JP)

(21) Appl. No.: 11/060,651

(22) Filed: Feb. 17, 2005

(30) Foreign Application Priority Data
Feb. 25, 2004 (JP) JP2004-049251

(51) Int. Cl. C08K 3/00

(52) U.S. Cl. 522/75; 522/168

(57) ABSTRACT

An inkjet recording ink which is activated light cure ink, containing cation polymerized monomer, initiator and pigment, wherein the moisture content for measurement by the Karl-Fischer method is 1.50 through 5.00 percent by mass and the pH value of the pigment is 4 through 10.

### TECHNICAL FIELD

The present invention relates to activated light cure type inkjet recording ink characterized by outstanding storage stability.

### BACKGROUND

In recent years, the inkjet recording method creates an image in a simple manner at a reduced cost, and is therefore employed in a wide variety of fields of printing, such as photographing, various types of printing, marking, special printing of color filters or the like. This art provides image quality comparable to that of a silver halide photograph, using the recording apparatus for injecting minute dots and controlling the same; the ink characterized by improved color reproduction area, durability and ink jetting properties; and the special-purpose paper characterized by drastic improvement in ink absorbency, color development of coloring material and surface luster. Improvement of the image quality in the current inkjet recording art can be achieved only when a satisfactory recording apparatus, ink and special-purpose paper have all been realized.

However, the inkjet system requiring use of special-purpose paper involves the problems of restricted recording media and costly recording media. To solve these problems, at tempts have been made to use the inkjet method to record on a transfer medium different from special-purpose paper. To put it more specifically, the technique used in these attempts includes a phase change inkjet method where solid wax ink is used at a room temperature, a solvent based inkjet method where ink mainly including fast-drying organic solvent is employed, and an UV inkjet method where ultraviolet rays (UV) is utilized for crosslinking.

Of these, the UV inkjet method emits less offensive smell than the solvent-based inkjet method, and allows recording on a recording medium not provided with fast-drying feature or satisfactory ink absorbency. For these advantages, the UV inkjet method has come to call attention in recent years. For example, ultraviolet cure type inkjet ink is disclosed in the Official Gazettes of Japanese Patent Tokkohei 5-54667, Tokkaihei 6-200204 and Tokuhyo 2000-504778.

For example, the ultraviolet cure type inkjet ink includes radical polymerized ultraviolet cure ink mainly composed of acrylic composition and cation polymerized ultraviolet cure ink mainly composed of acrylic composition. The radical polymerized ultraviolet cure ink is subjected to oxygen inhibition in an oxygen-present environment, because of its polymerization mechanism, and hence curability is impaired, on the one hand. On the other hand, although cation polymerized ultraviolet cure ink is not affected by oxygen inhibition, it is more vulnerable to water content (moisture) on the molecular level, and has a problem in storage stability because dark reaction proceeds easily.

To ensure the satisfactory storage and stability of the cation polymerized composition per se without curing properties being impaired, Official Gazette of Japanese Patent Tokkai 2003-252979, for example, discloses the art for allowing water to be contained as a polymerization inhibitor. This method improves the keeping quality of the polymerized composition per se. However, in the case of cation polymerized activated light cure inkjet ink containing a cation polymerized monomer, initiator, pigment and various other additives, the storage stability of ink solution greatly changes depending on the type and property of the pigment to be used as a coloring material in particular when this method is used to control the amount of water content. This has made it difficult to use this method directly so far.

### SUMMARY

The present invention provides activated light cure ink for inkjet recording, containing a cation polymerized monomer, initiator and pigment, characterized in that the moisture content for measurement by the Karl-Fischer method and the pH value of the pigment specified in JIS K5101 are defined.

### BRIEF DESCRIPTION OF THE DRAWINGS

FIG. 1 is a conceptual diagram representing a polymeric dispersant used in the present invention;

FIG. 2 is a conceptual diagram representing another polymeric dispersant used in the present invention;

FIG. 3 is a conceptual diagram representing still another polymeric dispersant used in the present invention;

FIG. 4 is an overall perspective view representing an inkjet printer comprising a heating means that can be used in the present invention;

FIG. 5 is an approximate plan view representing the positional relationship between the inkjet recording head and optical fiber top end, and positional relationship between the inkjet recording head and the heat plate; and

FIG. 6 is an approximate front view representing the positional relationship between the inkjet recording head and optical fiber top end, and positional relationship between the inkjet recording head and the heat plate.

### DETAILED DESCRIPTION OF THE PREFERRED EMBODIMENT

The aforementioned object of the present invention can be achieved by the following arrangements:

(1) Activated light cure ink for inkjet recording, containing cation polymerized monomer, initiator and pigment, wherein the moisture content for measurement by the Karl-Fischer method is 1.50 through 5.00 percent by mass and the pH value of the pigment specified in JIS K5101 is 4 through 10.

(2) The activated light cure ink for inkjet recording, described in (1), wherein the pigment is dispersed using the pigment dispersant comprising a basic anchor portion.

(3) The activated light cure ink for inkjet recording, described in (2), wherein the ratio between the pigment dispersant and pigment is 0.2 through 1.0.

(4) The activated light cure ink for inkjet recording, described in (2) or (3), containing a basic compound in addition to pigment dispersant.

(5) The activated light cure ink for inkjet recording, described in any one of (1) through (4), containing at least one type of oxetane compound as a cation polymerized monomer.

(6) The activated light cure ink for inkjet recording, described in any one of (1) through (5), containing at least one type of compound provided with oxirane ring as a cation polymerized monomer.

The present invention provides ultraviolet cure ink for inkjet recording, characterized by outstanding storage stability.

The following describes the best forms of embodiments of the present invention, without the present invention being restricted thereto.

The following provides a detailed description of the present invention:

In a cation polymerized composition, it is known that water as an electron donor works as a cation scavenger, and therefore discourages the crosslinking as a polymerization inhibitor, thereby ensuring storage stability. In the aforementioned Official Gazette of Japanese Patent Tokkai 2003-252979, for example, 1 through 10 percent of water by mass is contained in 100 parts of cation polymerized compound by mass, and 0.1 through 20 parts of cation polymerization initiator by mass.

However, the activated light cure ink of the present invention contains the additives required in the ink including a pigment as a coloring material, in addition to the cation polymerized monomer and initiator, and the working conditions (storage conditions) to which the inkjet ink is exposed is severer. Accordingly, mere control of water content is insufficient to get the satisfactory keeping quality and stability as inkjet ink, in the prior art. The present inventors have found out that the activated light cure inkjet ink requires control of the pH value of the pigment assumed as reflecting the properties of the pigment surface, as well as the water content.

Thus, in the activated light cure ink for inkjet recording in the present invention, the water content should be 1.5 through 5.00 percent by mass in terms of the water content for measurement by the Karl Fischer method; furthermore, the properties of the pigment surface are important. At the same time, to improve the storage stability of the inkjet ink, it is necessary to use the pigment wherein the pigment by the measurement method specified in the JIS K5101 has the pH value of 4 through 10.

To get the pH value of the pigment, the pH value of an aqueous suspension of pigment, viz., the sample obtained by allowing 5 g of pigment to be suspended in 100 ml of water is measured as specified in the JIS K5101. The sample is measured after having been shaken and mixed at the normal temperature for one minute. If the pH value is not changed by boiling, the boiling method is utilized. If it exhibits a drastic change, the normal temperature method is employed. These and other measurement details conform to JIS K5101.

If the water content is lower than 1.50 percent by mass, ink storage stability will deteriorate. If it is higher than 5.00 percent by mass, ink durability will drastically deteriorate. The situation will be particularly serious when the ink is to be cured immediately after it has reached the recording medium, in order to improve image quality.

In the case of the pigment ink, if the pH value of the pigment used as a coloring material is lower than 4, the storage stability of ink will be lowered even if the aforementioned water content is maintained. If the pH value is higher than 10, ink curability per se will be reduced. The pH of the pigment is preferably kept within the range from 5 through 8.

In the activated light cure ink for inkjet recording, it is preferred that the basic pigment dispersant should be used and the ratio between the pigment dispersant and pigment (in terms of mass ratio) should be 0.2 through 1.0. More preferably, this ratio is 0.4 through 0.6. This is especially effective when the pH value of the pigment obtained from the aforementioned measurement is less than 7. If the ratio between the pigment dispersant and pigment is smaller than 0.2, the ink storage stability tends to reduce. Further, if the ratio between the pigment dispersant and pigment is greater than 1.0, ink curability will reduce.

The following lists up the pigment preferably used in the present invention:
C.I Pigment Yellow 1, 3, 12, 13, 14, 17, 42, 74, 81, 83, 87, 93, 95, 109, 120, 128, 138, 139, 151, 166, 180, 185
C.I Pigment Orange 16, 36, 38
C.I Pigment Red 5, 22, 38, 48:1, 48:2, 48:4, 49:1, 53:1, 57:1, 63:1, 101, 122, 144, 146, 177, 185
C.I Pigment Violet—19, 23
C.I Pigment Blue—15:1, 15:3, 15:4, 18, 60, 27, 29
C.I Pigment Green—7, 36
C.I Pigment White—6, 18, 21
C.I Pigment Black—7

The aforementioned pigment can be dispersed by a ball mill, sand mill, atrighter, roll mill, agitator, Henschel mixer, colloid mill, ultrasonic homogenizer, pearl mill, wet jet mill, paint shaker and others. A solvent or polymerized compound can be used as a dispersion medium. In the activated light cure ink of the present invention, reaction and curing are started immediately after ink has hit the recording medium, and therefore, it is preferred not to use a solvent. If the solvent remains on the image subsequent to curing, solvent resistance will deteriorate and a VOC problem with the remaining solvent will arise. Thus, adequate dispersion is ensured by selecting polymerized compound, particularly the monomer having the least viscosity, instead of solvent.

For dispersion of the pigment, it is preferred that the mean particle size of the pigment should be 0.08 through 0.5 μm. The pigment, dispersant and dispersion medium are set and the dispersion condition and filtering conditions are set in such a way that the maximum particle size will be 0.3 through 10 μm or preferably 0.3 through 3 μm. This particle size management reduces the clogging of the head nozzle, and maintains the ink storage stability, ink transparency and cure sensitivity.

In the ink of the present invention, the density of the pigment as a coloring material is preferably 1 through 10 percent of the entire ink by mass.

A polymeric dispersant having a basic anchor is preferably used as the pigment dispersant. The anchor can be defined as the site in the polymeric pigment dispersant molecule for adsorbing the aforementioned pigment surface. In the present invention, storage stability of ink is improved by preferably using the polymeric pigment dispersant having a basic anchor, especially when an acid pigment is used.

A preferred polymer is the branched polymer, shaped like a comb and containing a branched portion structure in the molecule, wherein an anchor is contained in the main chain and the partial structure branched off from the main chain is provided on the side chain. It is also possible to use a comb-shaped polymer wherein basic group serving as an anchor is located on the side chain (terminal thereof, etc.). The basic group serving as an anchor includes a (substitutional) amino group and (substitutional) quaternary ammonium salt group.

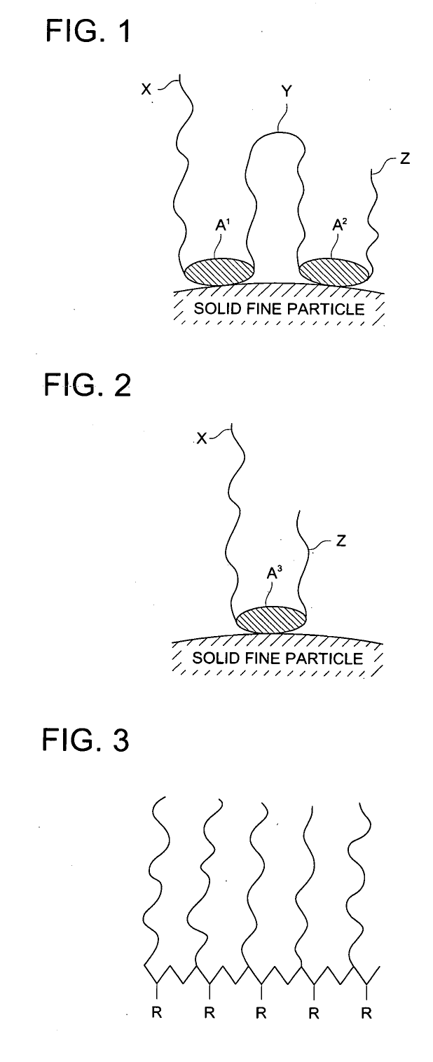

FIG. 1 shows the conceptual diagram representing the polymeric dispersant used of the present invention. In the general formula [X-A¹-Y-A²-Z], A¹ and A² indicate the portion (anchor) adsorbing the solid fine particle. If A¹ and A² have at least one point adsorbing the solid fine particle (adsorbing point), there is no restriction on the structure thereof. For example, it is formed in a form of chain, cycle, condensed polycycle and combination thereof. A¹ and A² can be either the same with each other or different from each other. In the meantime, X, Y and Z denote the polymeric chain portions that are solvated to spread from the solid fine particle surface into the solution. “X” and “Z” will be called the tail and “Y” the loop hereinafter. The homopolymer containing a single monomer, and the copolymer containing multiple monomers are used in the tail and loop.

The case of polymeric dispersant used in the present invention includes the case where the loop (Y) is not present in the general formula [X-A¹-Y-A²-Z], wherein the formula is synonymous with the general formula [X-A¹-Y-A²-Z]. Further, an arrangement where two tails are bonded to one anchor, without the presence of Y, can be used as a special case of the polymeric dispersant used in the present invention. In this case, the general formula [X-A³-Z] holds (see FIG. 2).

The A¹ and A² that constitute the polymeric dispersant used in the present invention (hereinafter A¹, A² and A³ may be collectively called “A”) have at least one functional group (adsorbing point) that provides mutual adsorption with solid particle surface, for example, due to hydrogen bondage and acid/base interaction. Further, A¹ and A² can be the same or different from each other. When the adsorption to the solid fine particle is taken into account, the one having the same functional group is preferred as a functional base (adsorbing point). From the viewpoint of production, it is more preferred that A¹ and A² should be the same.

Further, X, Y and Z constituting the polymeric dispersant used in the present invention may be composed of the chemical species different from one another, or at least two of them may be composed of the same chemical species. Such a tail and loop solvate to spread from the surface of the solid particular surface into the solution; accordingly, use is made of the polymeric chain having a close affinity with the solvent that disperses the solid fine particular. The polymeric chain, having a close affinity with the solvent, constituting the tail and loop, is selected, on condition that solubility parameter δp of such a polymeric chain and solubility parameter δs of the cation polymerized compound serving as a dispersant or solvent meet preferably |δp-δs|<8J^{1/2} cm^{3/2}, more preferably |δp-δs|<6J^{1/2} cm^{3/2} and still more preferably |δp-δs|<4J^{1/2}cm^{3/2}.

The solubility parameter is described, for example, in J. Brandrup and E. H. Immergut, Polymer Handbook Third Edition, John Wiley & Sons, 1989. Alternatively, it can be calculated from the method described, for example, in D. W. Van Krevelen, Properties of Polymers, Elsevier, 1976. When the cation polymerized compound serving as a dispersant or solvent is not single, or the polymeric chain of the polymeric dispersant is a copolymer, at least any one of the constituents (in units of cation polymerized compounds or solvent molecules to be used when the disperse medium is of a mixed type, and in units of the monomer constituting the polymer in the case of a copolymer) is selected on condition that the aforementioned relationship is met. When the disperse medium is of a mixed type, the molecule where the disperse medium is present in the greatest quantity (in terms of percent by mass) is selected. When the polymeric chain is a copolymer, the monomer unit present in the greatest quantity (in terms of percent by mass) is preferably selected.

The number average molecular weight of the overall polymeric dispersant used in the present invention is preferably 1000 or more, more preferably 2000 or more, and especially preferably 3000 or more. It is preferably 50000 or less, more preferably 30000 or less, and especially preferably 20000 or less.

There is restriction to the method of manufacturing the polymeric dispersant represented by the general formula [X-A¹-Y-A²-Z] used in the present invention. Each of the units X, A¹, Y, A² ad Z can be sequentially polymerized and synthesized, using the living anion polymerization, living cation polymerization or living radial polymerization, for example (method 1). They can also be synthesized by using the precursor of the anchor having a multifunctional terminal group, the precursor of the tail having a uni-functional terminal group, and the precursor of the loop having a bifunctional terminal group (method 2).

A configuration of the general formula [X-A¹-Y-A²-Z] of the present invention according to the method 2 can be obtained by reacting each constitutional unit in the range from 0.9 through 1.1 times the theoretical composition ratio. Normally, the polymeric dispersant having the intended structure on an average can be obtained by the feed composition ratio in this reaction. It is more preferred that reaction should be conducted in such a way that the number average molecular weight Mn having been actually measured lies Within the range 0.7 through 1.5 times the theoretical average molecular weight of the polymeric dispersant obtained from adding up the number average molecular weight and composition ration of each constituent unit, and the mass average molecular weight Mw having been actually measured will be Mw/Mn=4. Outside this range, the amount contained therein will be insufficient and the effect of the present invention may not be sufficiently obtained.

The chemical structure of X, Y, Z, A¹ and A² mentioned above depends on the type of the solid fine particle to be dispersed and the type of the disperse medium (ink component such as a cation polymerized compound), and cannot be generalized. For example, in the second method, when the precursor of the anchor including the isocyanate group is used as a multifunctional terminal, the oligomer including the monovalent OH group can be used as the precursor of the tail. To put it more specifically, this includes the one-side terminal hydroxyl group, such as polyether glycol, polyester-glycol, polycarbonate glycol or polyolefin glycol that has been esterified by acryl group.

Further, the polymeric diol can be exemplified as the precursor of the loop. To put it more specifically, it includes polyether glycol, polyester glycol, polycarbonate glycol, polyolefin glycol and a combination of at least two of them. Of these, polyolefin glycol is preferred, and polyethylene glycol or and polypropylene glycol are more preferred.

FIG. 3 shows the conceptual diagram of another polymeric dispersant used in the present invention. It contains a comb-shaped copolymer as shown in FIG. 3, where “R” denotes such a basic functional base as OH group, amine group, amino group and quaternary ammonium salt. The basic functional base may be a structure included in the main chain aggregate.

The main chain (anchor) shown in jaggies in FIG. 3 and side chain (polymeric chain) shown in a string indicate the copolymer or polymer of a vinyl-based compound, or a macromer or polymer of polyester compound. There is no restriction on the method of manufacturing the polymeric dispersant of this type. For example, this method includes chemical modification (esterification or amidation) of the molecular terminal functional group (OH group, amine group, amino group, or quaternary ammonium salt) on the side chain (polymeric chin) of the polymeric dispersant, using a compound having an acryl group.

The molecular weight (Mw) of the polymeric dispersant of this type used in the present invention is preferably about 10,000 through 1,000,000, more preferably 50,000 through 500,000, and still more preferably about 20,000 through 100,000.

The amount of the polymeric dispersant to be added preferably has a mass ratio of pigment dispersant/pigment=0.2 through 1.0, and more preferably has a mass ratio of pigment dispersant/pigment=0.4 through 0.6.

### EXAMPLE OF COMPOUND 1

440 g of tolylene diisocyanate trimmer (Mitec GP770A by Mitsubishi Chemical Industries, Ltd.; 49% of resin solid by mass, butyl acetate solution, 7.8% of NCO content by mass, number average molecular weight: 1080; average NCO group per molecule: 4.1), 1.1 g of dibutyltin dioctoate as catalyst, and 912 g of PGMEA (propylene glycol monomethyl ether acetate) sufficiently dehydrated as solvent were prepared under the atmosphere of nitrogen, and were heated and dissolved at a temperature of 70° C. for 30 minutes. While it was agitated, 400 g of polyethylene glycol having a number average molecular weight of 2000, the terminal on one side being butanoyl group, was added thereto. Then reaction was carried out at 70° C. for two hours until the amount of NCO group contained therein would reach 1.5% of the theoretical residual amount by mass.

Then 100 g of polypropylene glycol having a number average molecular weight of 1000 (SANIX PP-1000 by Sanyo Chemical Industries, Ltd.) was added, and reaction was carried out at 80° C. for two hours until the amount of NCO group contained therein would reach 1.0% of the theoretical residual amount by mass. Then 9.5 g of n-propanol (PrOH) was added, and reaction was carried out at 40° C. for 1.5 hours until the amount of NCO group contained therein would reach 0.6% of the theoretical residual amount by mass. Finally, 32.5 g of aminopropyl imidazole (API) was added and reaction was conducted at 40° C. for one hour to allow all the remaining NCO groups to react, whereby a dispersant solution having a solid concentration of 40% by mass was obtained. The viscosity of this dispersant solution was 1730 mPa/sec. The polystyrene equivalent number average molecular weight of this dispersant was 7,800, and Mw/Mn=3.5.

The polymeric dispersant in the Example of compound 1 is equivalent to the case of A¹=A² and X=Z in the general formula [X-A¹-Y-A²-Z]. The precursors of A¹ and A² are constituent units composed of API having been added to the trimer of tolylene diisocyanate, the precursors of X and Z are polyethylene glycol as a butanoyl group, and the precursor of Y is a polypropylene glycol. The mole ratio of each composition assigned in the reaction was A¹:X:Y=2:2:1, which corresponds to the arrangement of the aforementioned general formula.

### EXAMPLE OF COMPOUND 2

A dispersant solution was obtained in the same manner as that in Example of compound 1, except that the amount of polyethylene glycol having a number average molecular weight of 2,000 as a butanoyl group to be added was 800 g, without SANIX PP-100 being added, and the PGMEA was regulated so that solid concentration would reach 40% by mass. The polystyrene equivalent number average molecular weight of this dispersant was 6,200, and Mw/Mn=3.2. The polymeric dispersant of the Example of compound 2 corresponds to the general formula [X-A³-X], wherein the precursor of A³ is the constituent unit composed of API having been added to the trimer of tolylene diisocyanate, and the precursor of X is polyethylene glycol as a butanoyl group. The mole ratio of each composition assigned in the reaction was A³:X=1:2, which corresponds to the arrangement of the aforementioned general formula.

### EXAMPLE OF COMPOUND 3

In the presence of titanium (IV) butylate catalyst (0.28 g), 101.4 g of stearic acid and 43.90 g of caprolactone were agitated at 170° C. for six hours in the atmosphere of nitrogen. Then 11.10 g of polyethyleneimine having a molecular weight of 20,000 was added to the mixture and was agitated at 120° C. for six hours in the atmosphere of nitrogen. Thus, a comb-shaped copolymer was obtained, wherein the main chain (anchor) had multiple basic functional groups and multiple hydroxyl groups are arranged on the chain of the molecular side (polymeric chain portion). The copolymer obtained in this manner was added to 900 g of sufficiently dehydrated PGMEA (propylene glycol monomethyl ether acetate), and was heated and dissolved at 70° C. for 30 minutes. While it was agitated and cooled, 18 g of chloride pentanoic acid was dropped for 30 minutes to get a polymeric dispersant.

The other specific examples of the pigment dispersant usable in the present invention include Solsperse 9000, 17000, 18000, 19000, 20000, 24000SC, 24000GR, 28000 and 32000 by Avecia; Ajisper PB 821 and PB822 by Ajinomoto Fine Techno; PLAAD ED214 and ED251, and DISPARLON DA-325 and DA-234 by Kusumoto Chemicals Co.; EFKA-5207, 5244, 6220 and 6225 by EFKA; and Disperbyk-161, -162, -163, -164, -166, -182, -2000, -2001, -2050 and -2150 by BYK-Chemie. Along with the pigment dispersant, the pigment derivative (Synergist) can be used. The specific examples of the pigment derivative includes Solsperse 5000, 12000 and 22000 by Avecia, and EFKA-6746 and -6750 by EFKA.

Further, the activated light cure ink for inkjet recording of the present invention preferably contains a basic compound in addition to the pigment dispersant.

The basic compound is a compound for neutralizing Lewis acid and Broensted acid, and includes the following:

The basic compound includes Lewis base of the organic compound, and its specific example contains a compound having an ester linkage in the molecule, a compound having an ether linkage, a compound having an urethane linkage, a compound having a carbonate linkage, hydroxylamine such as primary amine, secondary amine, tertiary amine and ethanoamine, primary phosphine, secondary phosphine, tertiary phosphine, pyridyl group, N-substitutional imidazolyl group, N-substitutional indazolyl group, nitrile group, azido group, N-substitutional imino group, N,N-substitutional amino group, N,N-substitutional aminooxy group, N,N,N-substitutional hydrazino group, nitrozo group, nitro group, nitrooxy group, carbonyl group, thiocarbonyl group, alkoxy group, alkyloxycarbonyl group, N,N-substitutional carbamoyl group, thioalkoxy group, substitutional sulfinyl group, substitutional sulfonyl group and substitutional sulfonic group.

To be more specific, the examples include aliphatic polyamines [alkylene diamine (ethylene diamine, tetramethylene diamine, hexamethylene diamine, etc.) polyalkylene (the carbon number of alkylene: 2 through 6), polyamine (diethylene triamine triethylene tetramine, pentaethylene hexamine, imino bispropyl amine, bis (hexane methylene), triamine, etc.), alkyl or hydroxyl alkylamine compound (alkyl (carbon number: 1 through 3) aminopropyl amine, aminoethyl ethanolamine, methylimino bispropylamine, etc.), aliphatic amines including aromatic group (xylylene diamine, tetrachlor paraxylylene diamine, etc.), etc.]; fat or heterocyclic aliphatic amine (N-aminoethyl piperazine, 1, 3-diamino cyclohexane, Isophorone diamine hydrogenated methylene diamine, 3,9-bis (3-amino propyl)-2,4,8,10-tetraoxyaspiro-[5,5]undecane, etc.), aromatic polyamine (methaphenylene diamine, paraphenylene diamine, toluene diamine, diaminodiphenyl methane, diaminodiethyldiphenyl methane, diaminodiphenyl sulfone, benzine, 4,4′-bis(o-toluidine), thiodiazoline, dianisidine, methylene bis(o-chloroaniline), bis (3,4-diaminophenyl) sulfone, diamonoditolyl sulfone, 2,6-diamino pyridine, 4-chloro-o-phenylene diamine, 4-methoxy-6-methyl-m-phenylene diamine, m-aminobenzyl amine, 4,4′-diamino-3,3′-dimethyl diphenyl methane, etc.), polyamide polyamine (a condensate of the aforementioned polyamines and dimer acid); benzoguanamine, alkylguanamine or its modified compound, dicyanamide or its modified compound (AMICURE AH-154, AMICURE AH-162, etc. by Ajinomoto Co., Inc.), powdered dicyandiamide (AMICURE AH-150, etc. by Ajinomoto Co., Inc.), imidazols [imidazol, 2-methyl imidazol, 2-phenyl imidazol, 2-undesyl imidazol, 2-heptadesyl imidazol, 1-methyl imidazol, 2-ethyl-4-methyl imidazol, etc.], pyridine quinoline, N,N-dimethyl cyclohexane amine, triethyl amine, N-methyl morpholine, N-ethyl morpholine, triethylene diamine, N,N-dimethyl benzyl amine, tris(N,N-dimethyl aminomethyl) phenol, etc., 1,8-diazabicyclo[5,4,0]undecen-7, and phosphate compound, (trialkyl phosphine, trialkyl phosphine oxide, triphenyl phosphine derivative, phosphone amides, etc.).

The specific examples also include amine adduct (AMICURE PN-23, AMICURE MY-24, AMICURE PN-D, AMICURE MY-D, AMICURE PN-H, AMICURE MY-H, etc. by Ajinomoto Co., Inc.), imidazole/epoxy adduct (NOVACURE HX-3155, NOVACURE HX-3721, NOVACURE HX-3722, NOVACURE HX-3748, NOVACURE HX-3088, NOVACURE HX-3741, NOVACURE HX-3742, NOVACURE HX-3891, NOVACURE HX-3613, NOVACURE HX-3921HP, NOVACURE HX-3741HP, etc. by Asahi Chemical Industry Co., Ltd.), ketimine, organic acid hydrazide (AMICURE VDH, AMICURE UDH, AMICURE LDH by Ajinomoto Co., Ltd.), polyaminourea (FUJICURE FXE-1000 and FUJICURE FXR-1030 by Fuji Chemical Co., Ltd.), amine imide and their modified substances. They can be used independently or in combination of two or more.

In the meantime, the basic compound includes the Lewis base as an inorganic compound. To put it more specifically, it is exemplified by sodium methoxide, sodium ethoxide, caustic potash, caustic soda, sodium carboxylate salt, potassium carboxylate salt, sodium carbonate, potassium carbonate, sodium hydrogen carbonate, and potassium hydrogen carbonate. It is also possible to use the latent base generator that produces basicity through activated light and/or heat of dicyandiamide, amine adduct, imidazole/epoxy adduct, ketimine, organic acid hydrazide, amineimide or the like.

The amount of the basic compound contained in the activated light cure ink for inkjet recording is preferably 0.01 through 5% by mass and more preferably 0.05 through 1% by mass.

Use of the activated light cure ink with water content and pH value of the pigment adjusted within the aforementioned range allows a stable high-definition image to be formed, independently of the ink storage environment (temperature and humidity). Further, the ink feed system from the ink container to the recording head is preferably configured in an enclosed form, whereby the effect of the present invention is further encouraged.

For the inkjet recording ink of the present invention, an oxetane compound or a compound provided with oxirane ring are used as a cation polymerized monomer.

For the cation polymerized monomer, control of the pH value of the pigment, in addition to the water content of ink, is particularly effective when the oxetane compound is contained therein. Greater advantages can be expected if the oxetane compound and compound provided with oxirane group are used in combination.

The initiator, for example, includes a chemical amplification type photoresist and compound used for optical cation polymerization photooxygenation agent introduced in “Organic Material for Imaging”, edited by Organic Electronic Material Research Association, Binshin Publishing Co., PP. 187-192, and “Photocure Technology” edited by Technological Information Association, 2001). The following shows examples of the compounds suited for use in the present invention: In the first place, aromatic onium compound B (C₆f₅)₄, PF₆⁻, AsF₆⁻, SbF₆⁻, CF₃SO₃⁻ salt, such as diazonium, ammonium, iodonium and sulfonium can be mentioned. The specific example of the onium compound is given below.

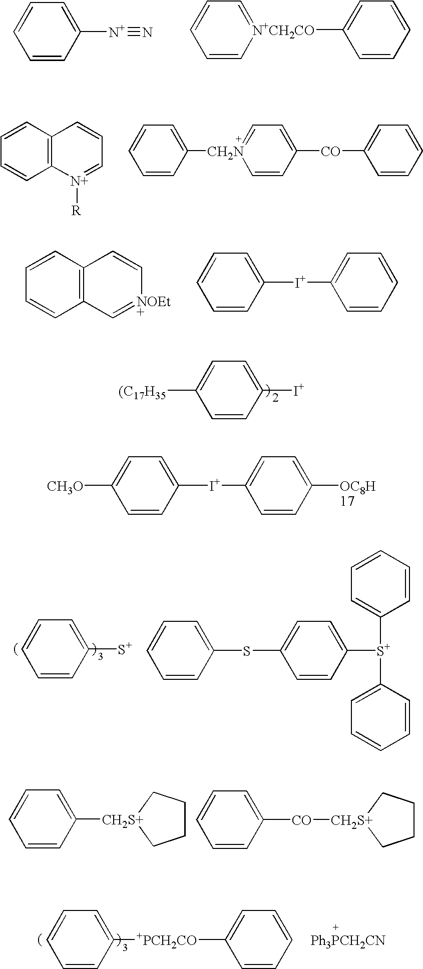

Second, a sulfone compound for generating a sulfonic acid can be mentioned. The following describes a specific compound:

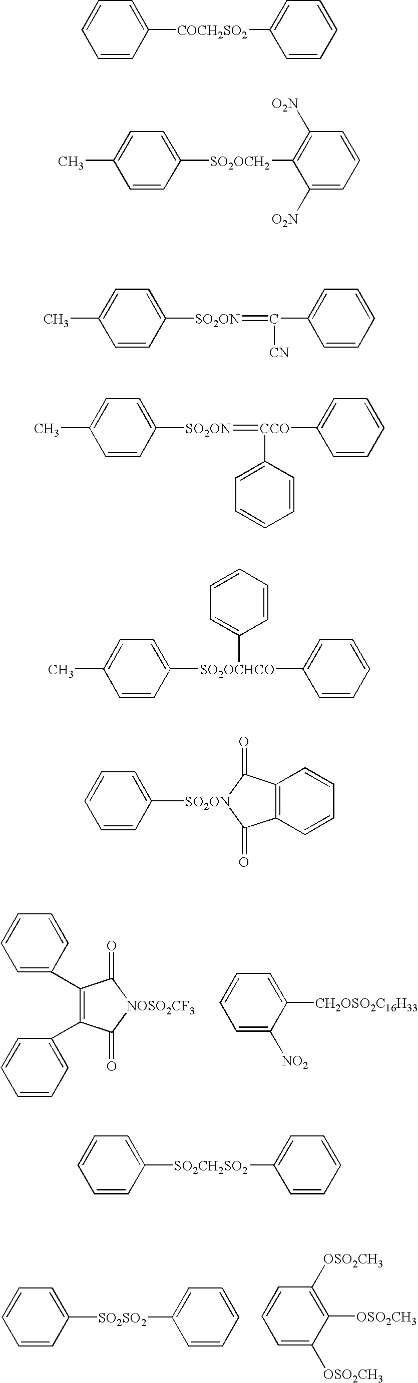

Third, a halogen compound that provides optical generation of halogenated hoyden can be utilized. The following describes a specific compound:

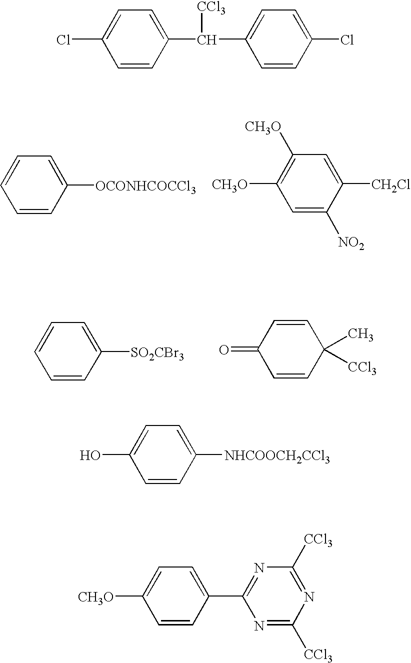

Fourth, an iron allene complex can be mentioned.

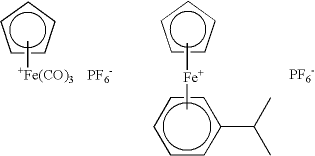

The ink of the present invention preferably contains an oxygen proliferation agent for generation of new oxygen, using the oxygen generated by application of activated light that is already known as it is disclosed in Official Gazettes of Japanese Patents Tokkaihei 8-248561 and 9-34106 and others. Use of the oxygen proliferation agent ensures further improvement of the emission stability.

The following describes the oxetane compound used in the present invention:

The oxetane compound is a compound provided with an oxetane ring. For example, it is possible to use the all the known oxetane compounds introduced in the Japanese Patent Tokkai 2001-220526 and 2001-310937.

If a compound having five oxetane rings is used, the viscosity of the composition will be increased, and handling will be difficult. Further, since the glass transition temperature of the composition is raised, the adhesive strength of the obtained cure substance will be insufficient. The compound provided with oxetane ring used in the present invention preferably contains one through four oxetane rings.

The compound containing one oxetane ring includes the one given in the following general formula (1):

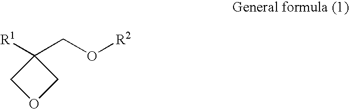

In formula (1), R¹ denotes:
a hydrogen atom,
an alkyl group having a carbon number of 1 through 6, including methyl group, ethyl group, propyl group or butyl group;
a fluoroalkyl group having a carbon number of 1 through 6,
an allyl group, an aryl group, furyl group or thionyl group.
R² indicates:
an alkyl group having a carbon number of 1 through 6, including methyl group, ethyl group, propyl group or butyl group;
an alkenyl group having a carbon number of 2 through 6, including 1-propenyl group, 2-propenyl group, 2-methyl-1-propenyl group, 2-methyl-2-propenyl group, 1-butenyl group, 2-butenyl group or 3-butenyl group;
a group having aromatic ring, including phenyl group, benzyl group, fluorobenzyl group, methoxybenzyl group or phenoxyethyl group;
an alkylcarbonyl group having a carbon number 2 through 6, including ethylcarbonyl group, propylcarbonyl group or butylcarbonyl group;
an alkoxycarbonyl group having a carbon number 2 through 6, including ethoxycarbonyl group, propoxycarbonyl group or butoxycarbonyl group; or
an N-alkylcarbamoyl group having a carbon number of 2 through 6, including ethylcarbamoyl group, propylcarbamoyl group, butylcarbamoyl group or pentylcarbamoyl group.

The following describes the compound having two oxetane rings expressed by the following general formula 2:

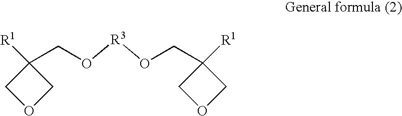

In the Formula 2, R¹ denotes the same as the aforementioned general formula (1). R³ indicates
a linear or branched alkylene group, including ethylene group, propylene group or butylene group;
a linear or branched poly(alkyleneoxy) group, including poly(ethyleneoxy) group or poly(propyleneoxy) group;
a linear or branched unsaturated hydrocarbon group, including propylene group, methyl propnylene group or butenylene group;
   a carbonyl group;
   an alkylene group including carbonyl group;
   an alkylene group including carboxyl group; or an alkylene group including carbamoyl group.

R³ can be a polyvalent group selected from the groups shown by the following general formulas (3), (4) and (5).

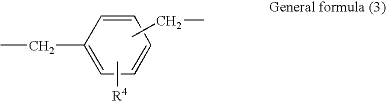

In the Formula (3), R⁴ denotes:
a hydrogen atom;
an alkyl group having a carbon number of 1 through 4, including methyl group, ethyl group, propyl group or butyl group;
an alkoxy group having a carbon number 1 through 4, including methoxy group, ethoxy group, propoxy group or butoxy group;
   a halogen atom including chlorine atom or bromine atom;
   a nitro group, a cyano group, a mercapto group, a lower alkoxy carbonyl group, a carboxyl group, or carbamoyl group.

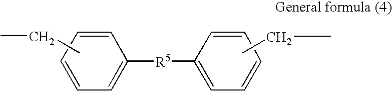

In the Formula (4), R⁵ denotes an oxygen atom, a sulfur atom, a methylene group, NH, SO, SO₂, C(CF₃)₂ or C(CH₃)₂

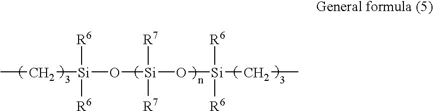

In the Formula (5), R⁶ denotes an alkyl group having a carbon number of 1 through 4, including a methyl group, ethyl group, propyl group or butyl group; or an aryl group. “n” indicates an integer from 0 through 2000. R⁷ shows an alkyl group having a carbon number of 1 through 4, including a methyl group, ethyl group, propyl group or butyl group. R⁷ can be a group selected from the groups shown by the following general formula (6).

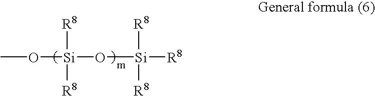

In the Formula (6), R⁸ denotes an alkyl group having a carbon number of 1 through 4, including a methyl group, ethyl group, propyl group or butyl group; or an aryl group. “m” indicates an integer from 0 through 100. The compounds containing two oxetane rings include the following:

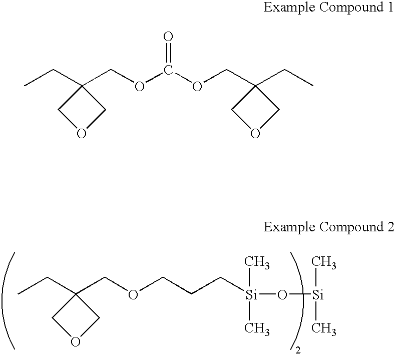

The compound 1 illustrated in the Formula (2) is a compound where R¹ denotes an ethyl group and R3 a carboxyl group. The compound 2 illustrated in the Formula (2) is a compound where R¹ denotes an ethyl group, R³ the Formula (5), R⁶ and R⁷ a methyl group, and “n” 1. In the compound having two oxetane rings, the preferred examples other than the aforementioned ones include the compound expressed in the following general formula (7): In the Formula (7), R¹ indicates the same group as shown in the aforementioned general formula (1).

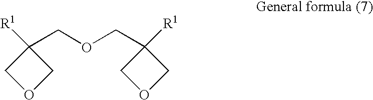

The compounds containing three through four oxetane rings include the ones expressed in the following general formula (8):

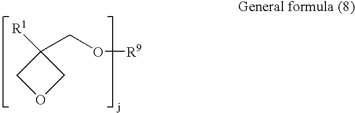

In the Formula (8), R¹ indicates the same group as shown in the aforementioned general formula (1). R⁹ represents a branched alkylene group having a carbon number of 1 through 12, including the group shown by the following A through C; a branched poly(alkyleneoxy) group, including the group shown by the following “D”; or a branched polycyloxy group shown by the following E. “j” indicates 3 or 4.

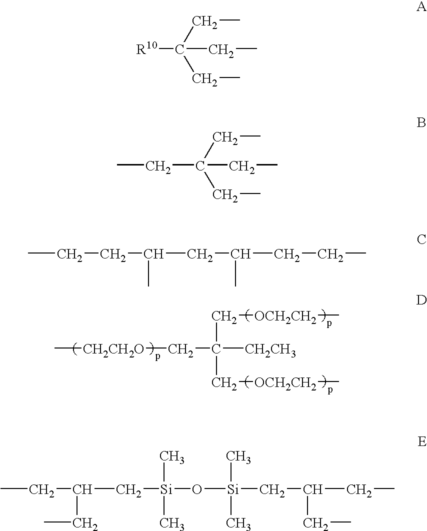

In the aforementioned “A”, R¹⁰ shows a lower alkyl group such as methyl group, ethyl group, or propyl group. In the aforementioned D, “p” is 1 through 10.

A specific example of the compound having three through four oxetane rings is given by the illustrated compound:

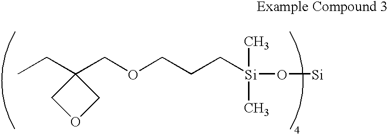

Further, a specific example of the compound except for the compound having one through four oxetane rings mentioned above includes the compound given by the following general formula (9):

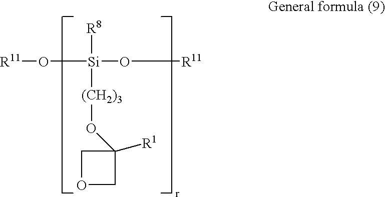

In the formula (9), R⁸ indicates the same as shown in the aforementioned formula (6). R¹¹ shows the alkyl group having a carbon number of 1 through 4, including the methyl group, ethyl group, propyl group or butyl, or trialkylsilyl group. “r” indicates 1 through 4.

A specific example of the compound preferably used in the present invention the compounds 4 to 6 illustrated below:

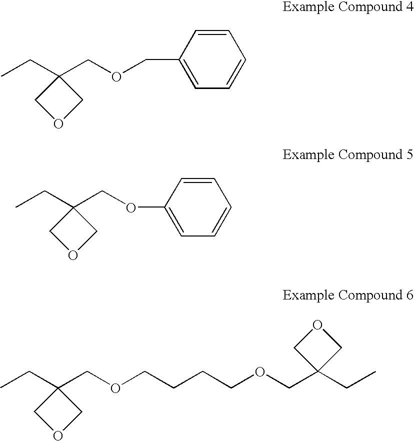

There is no restriction to the method of manufacturing the compound having the aforementioned oxetane ring. It can be manufactured according to prior art practice. For example, there is an oxetane biosynthetic method, disclosed by Pattison (D. B. Pattison, J. Am. Chem. Soc., 3455, 79 (1957)), for synthesizing from diol. Further, compounds, each having a high molecular weight of about 1,000 through 5,000, provided with 1 through 4 oxetane rings can also be mentioned. They include the following compounds:

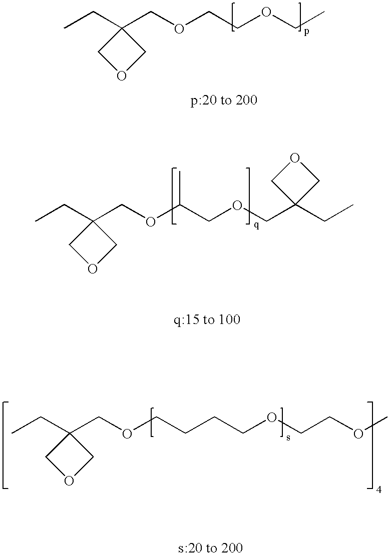

In the present invention, it is preferred to use what contains the compound having a least one type of oxirane group as a cation polymerized monomer, along with the aforementioned oxetane compound. Sensitivity and storage stability are improved by concurrent use of these oxetane compounds and the compound having the aforementioned oxirane group.

Aromatic epoxide and aliphatic ring epoxide are available as a compound having an oxirane ring (epoxy compound). Of these, what is preferred as an aromatic epoxide includes di- or poly-glycidyl ether produced by reaction between the polyvalent phenol having at least one aromatic nucleus or its alkylene oxide adduct and epichlorhydrazine. It includes, for example, di- or poly-glycidyl ether of bisphenol A or its alkylene oxide adduct; di- or poly-glycidyl ether of hydrogen added bisphenol A or its alkylene oxide adduct; and novolak based epoxy resin. Alkylene oxide includes the ethylene oxide and propylene oxide.

The aliphatic ring based epoxide is obtained by epoxidation of at least one cyclohexene or a compound containing a cyclealkane ring such as cyclopentene ring, using an appropriate oxidizing agent such as hydrogen petroxide and peroxy acid. A compound containing the cyclohexene oxide or cyclopenten oxide is preferred.

The preferred aliphatic epoxide includes di- or poly-glycidyl ether of aliphatic or its alkylene oxide adduct. It is typically represented by:
glycidyl ether of alkylene glycol, including diglycidyl ether of ethylene glycol, diglycidyl ether of propylene glycol or diglycidyl ether of 1,6-hexane diol ether;
polyglycidyl ether of polyvalent alcohol, including di- or tri-glycidyl ether of glycerin or its alkylene oxide adduct; and
diglycidyl ether of polyalkylene oxide adduct, including diglycidyl ether of polyethylene glycol and its alkylene oxide adduct, and diglycidyl ether of polypropylene glycol or its alkylene oxide adduct.

The ink of the present invention various additives in addition to what has been described. For example, it is possible to add a surface active agent, leveling additive, matting agent, polyester based resin for regulating the film properties, polyurethane resin, vinyl resin, acryl resin, rubber resin and waxes. Further, a radical polymerized monomer and initiator can be mixed to form hybrid cure ink of radical cation.

In the image forming method of the present invention, ink is emitted and exposed on a recording medium by the inkjet recording method and is then exposed to the activated light such as ultraviolet rays, whereby ink is cured and an image is formed.

To ensure satisfactory ink emission stability, the recording head and ink should bed heated to 35 through 100° C. The activated light cure ink exhibits a large variation of viscosity due to temperature fluctuation. The variation of viscosity directly affects the ink particle size and ink particle emission speed to a larger degree, and causes deterioration of the image quality. To avoid this, the ink temperature must be maintained constant while being raised. The range of controlling the ink temperature is the setting temperature ±5° C., preferably the setting temperature ±2° C. and more preferably the setting temperature ±1° C.

In the present invention, the overall ink film thickness subsequent to hitting of the recording medium by ink, application of activated light and curing of ink is preferably 2 through 20 μm. Here the “overall ink film thickness” is defined as the film thickness of the ink exposed on the recording medium. The overall ink film thickness remains unchanged when recording is performed according to the inkjet recording method, whether in a single color, two colors (secondary color), three colors (tertiary color) or four colors (based in white ink). In the inkjet recording by activated light cure ink in the field of screen printing, the overall ink film thickness exceeds 20 μm. In the field of soft package printing where the recording medium is often a thin plastic film, there is a problem involving changes in the toughness and feel of overall printed matter in addition to curling and wrinkles of the recording medium.

In the present invention, the amount of ink particle emitted from each nozzle is preferably 2 through 0.15 pl. To form a high definition image, the amount of ink particle must remain within this range. When this amount of ink is emitted, severer conditions are imposed on emission stability, as described above.

In the image recording method of the present invention, the activated light is preferably applied in 0.001 through 2.0 sec.—more preferably 0.001 through 1.0 sec.—after the ink has reached the recording medium. To form a high definition image, it is particularly important that light be applied as soon as possible.

A basic method for application of activated light is disclosed in the Official Gazette of Japanese Patent Tokkaisho 60-132767, wherein a light source is arranged on both sides of the head unit, and the head and light source are scanned according to the shuttle technique. Light is applied some time after the ink has reached the recording medium. Further, curing is performed by another light source which does not require driving. According to the light application method disclosed in the U.S. Pat. No. 6,145,979, an optical fiber is used, or the mirror surface with a collimated light source arranged on the side of the head unit is used to apply the ultraviolet ray to the recording section. In the image formation method of the present invention, any of these methods can be used.

Further, activated light is applied in two separate phases. First, activated light is applied in the aforementioned manner in 0.001 through 2.0 sec. subsequent to the ink having reached the recording medium. Another preferable way is to apply light again after termination of the entire printing. Application of activated light in two separate phases reduces shrinkage of the recording medium that may occur at the time of ink curing.

In the image forming method of the present invention, the ink component is emitted and exposed on the recording medium by the inkjet recording method and the activated light such as ultraviolet ray is then applied. Furthers the ink is heated, whereby the ink is cured. This procedure is preferable when an high definition image is formed.

The following describes an example of the inkjet recording apparatus of the present invention:

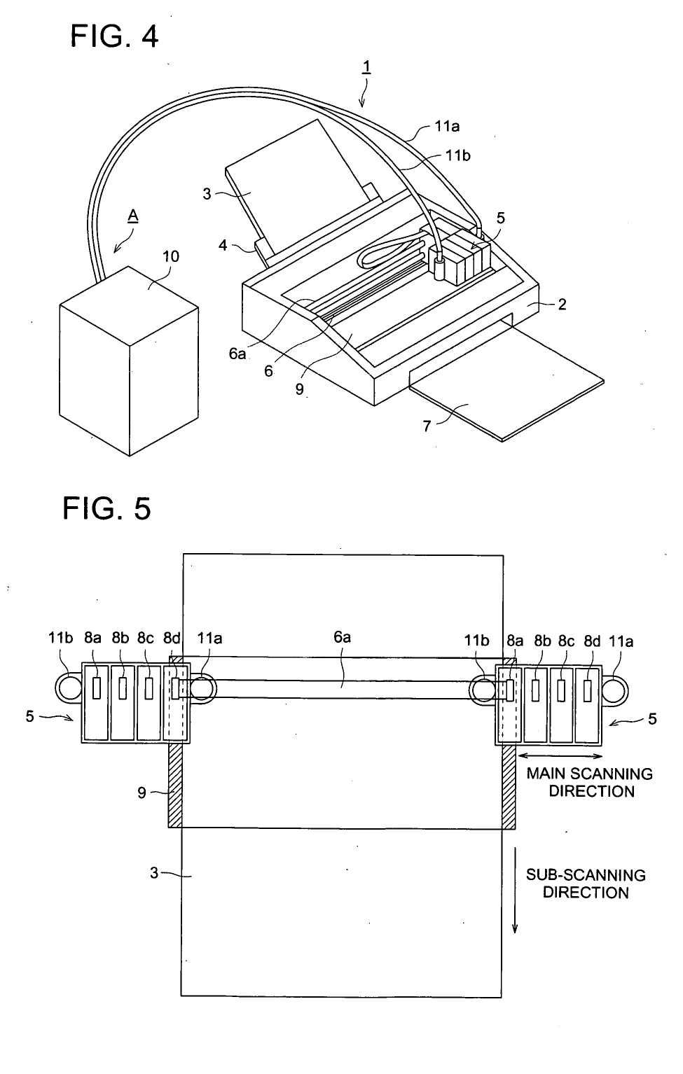

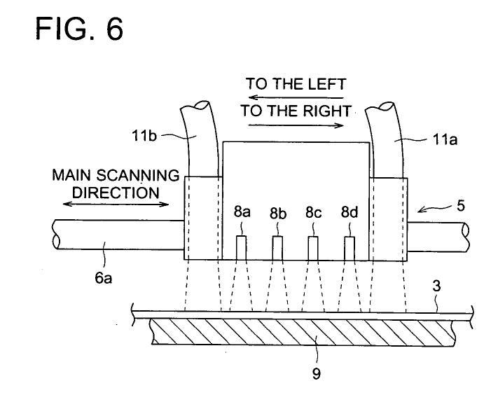

FIG. 4 is an overall perspective view of the inkjet printer provided with a heating means for use in the present invention. FIG. 5 is a schematic plan view representing the positional relationship between the inkjet recording head and the tip end of an optical fiber, and the positional relationship with respect to a heater plate. FIG. 6 is a schematic front view representing the positional relationship between the inkjet recording head and the tip end of an optical fiber, and the positional relationship with respect to a heater plate.

As shown in FIG. 4, an inkjet printer 1 comprises:
a paper feeder 4, arranged over a printer 2, for a recording medium 3 as a printing medium;
a sheet conveyance means (not illustrated) for conveying the recording medium 3 set on the paper feeder 4, in the sub-scanning direction of an inkjet recording head 5 (the same as the direction for sheet conveyance) at a predetermined speed;
an inkjet recording head 5 for printing on the recording medium 3 conveyed by this sheet conveyance means;
an ultraviolet ray application apparatus A for applying an ultraviolet ray as activated light to the site reached by the cation polymerized activated light cure ink jetted by this inkjet recording head 5;
a heat plate 9 as a heating means for heating the activated light cure ink having reached the recording medium; and
an ejection section 7 for ejecting the recording medium 3 where printing is performed by the inkjet recording head 5.

The inkjet recording head 5 is of a serial on-demand type and is arranged so as to travel freely in the direction of main scanning (orthogonal to the sheet feed direction) between the right position and left position in FIG. 5, along the guide rod 6a of a head traveling section 6. The traveling range is set in such a way that, on the left side in FIG. 5, an optical fiber 11b on the left, and, on the right side in FIG. 5, an optical fiber 11a on the right will be located at least outside the end of the printing area of the recording medium 3. The inkjet recording head 5 has four nozzle heads 8a through 8d of inkjet type. These four nozzle heads 8a through 8d are so arranged as to jet cation polymerized activated light cure ink of yellow, magenta, cyan and black to the recording medium 3. The injection timing of the nozzle heads 8a through 8d is controlled based on injection data.

In FIG. 4, the ultraviolet ray application apparatus A incorporates an ultraviolet lamp (not illustrated). It is provided with an ultraviolet ray generating section 10 for generating ultraviolet rays, and optical fibers 11a and 11b, arranged in two systems, for leading for leading the ultraviolet rays generated from the ultraviolet ray generating section 10. The tip ends of these optical fibers 11a and 11b are connected to both sides of the inkjet recording head 5 in the main scanning direction. The optical fibers 11a and 11b are designed in a soft and flexible configuration, and the flexibility is regulated in conformity to the traveling of the inkjet recording head 5, whereby the tip ends of these optical fibers 11a and 11b are moved in the main scanning direction along with the inkjet recording head 5.

The following describes the relationship between the position of the recording medium 3 reached by the activated light cure ink emitted from the inkjet recording head 5, and the position to which the ultraviolet rays of optical fibers 11a and 11b are applied. As shown in FIG. 6, when the inkjet recording head 5 moves from right to left, the optical fiber 11a scans the position having just been reached by the activated light cure ink. When the inkjet recording head 5 moves from left to right, the optical fiber 11b scans the position having just been reached by the activated light cure ink. To be more specific, each of the optical fibers 11a and 11b of two systems is responsible for application of ultraviolet rays to the inkjet recording head 5 in each scanning direction.

The heat plate 9 is arranged as part of the guide plate for guiding the conveyance of the recording medium 3 of the paper feeder 4 through the print position to the ejection section 7. The area of its arrangement covers the portion from the emission point of the inkjet recording head 5 over to the downstream side of conveyance. The heat plate 9 incorporates a heating element, and directly transmits heat to the recording medium 3 in contact therewith, thereby heating the activated light cure ink having reached.

In the aforementioned arrangement, when the cation polymerized activated light cure ink has been emitted from the inkjet recording head 5 to the recording medium 3, ultraviolet rays are applied to the activated light cure ink immediately after arrival of the ink (within ten sec.) The activated light cure ink having reached is heated by the heat plate 9. Thus, the activated light cure ink having reached is exposed to the ultraviolet rays at a temperature of more than a predetermined level, and curing reaction is activated. This allows the activated light cure ink to be cured sequentially, even in a highly humid environment. Thus, satisfactory printing is ensured by using the cation polymerized activated light cure ink even in a highly humid environment. Further, even when the recording medium 3 where ink tends to spread is used, ink does not spread thereon. This will provide printed matter highly resistant to rubbing.

In the present embodiment, the ultraviolet ray application apparatus A contains an ultraviolet ray generating section 10 for generating ultraviolet rays, and optical fibers 11a and 11b for leading the ultraviolet rays generated from the ultraviolet ray generating section 10, to the position close to the inkjet recording head 5. Since ultraviolet rays are emitted from the tip end of the optical fibers 11a and 11b, they are applied to the position of the recording medium 3 reached by ink, in the form of a spot from a short distance. Consequently, a required amount of ultraviolet ray can be provided by ultraviolet rays of small intensity, and this allows the ultraviolet ray application apparatus A to be manufactured in a smaller size at a reduced cost. Further, there is no need of preparing an ultraviolet lamp conforming to the printing width or moving the ultraviolet lamp itself. This configuration provides outstanding safety and durability.

In the present embodiment, the tip ends of the optical fibers 11a and 11b are connected to the inkjet recording head 5. In synchronization with the printing speed of the inkjet recording head 5, these fibers can be moved in the main scanning direction to ensure that light is applied to the site reached by the activated light cure ink immediately after its arrival. This eliminates the need of moving the ultraviolet ray generating section 10, and requires only the tip ends of the optical fibers 11a and 11b to be moved, with the result that the ultraviolet rays can be easily applied in quick response. Further, movement of the optical fibers 11a and 11b does not require any special device for their movement. This feature prevents the number of parts from being increased, and ensures control ease.

In the present embodiment, the optical fibers 11a and 11b in two systems are provided, and the tip ends of optical fibers 11a and 11b are each arranged on both sides of the inkjet recording head 5 in the main scanning direction. Arrangement is made to ensure that the optical fibers 11a and 11b in two systems are each responsible to apply light to the inkjet recording head 5 in each main scanning direction. Thus, independently of the direction in which the inkjet recording head 5 scans, ultraviolet rays are applied effectively immediately after the ink has reached the recording medium 3. This allows the activated light cure ink to be cured, without the need of changing the position of ultraviolet rays emitted from the tip ends of the optical fibers 11a and 11b.

In a variation of the present embodiment, it is also possible to make such arrangements that the optical fiber of one system alone is provided. When conforming to the inkjet recording head 5 performing printing in both main scanning directions, it is necessary to change the position of the ultraviolet rays emitted from the tip end of the optical fiber in such a way that the ultraviolet rays can be applied effectively immediately after arrival of the ink, regardless of the direction in which the inkjet recording head 5 scans. In the case of the inkjet recording head 5 for printing operation in one main scanning direction, there is no need of changing the position of the ultraviolet rays emitted from the tip end of the optical fiber.

The inkjet recording head can be designed as a line type on-demand configuration. In this case, it is necessary to provide a means for moving the optical fiber in the direction of main scanning.

In the present embodiment, heating is provided by a heat plate 9. However, heating can be provided by a-hot air blowing means for blowing hot air to the activated light cure ink having reached the recording medium 3. This configuration allows the hot air blowing means to blow air to the activated light cure ink having reached the recording medium, whereby the activated light cure ink is heated. If the hot air blowing means is arranged by leading the heat generated from the ultraviolet ray generating section 10, to the position close to the inkjet recording head 5 by means of a tube or the like, then there is no need of installing a hot air generating section at some midpoint, with the result that reduced number of parts, compact configuration and reduced cost can be achieved.

In the aforementioned description, the inkjet recording head 5 is assumed as a multicolor-ready head provided with a plurality of nozzle heads 8a through 8d. A single-color head can also be used.

The recording-medium that can be used in the present invention includes various types of non-absorbing type plastics and their film used for so-called soft packaging, in addition to normal plain paper and coated paper. The examples of various plastic films include PET film, OPS film, OPP film, ONy film, PVC film, PE film and TAC film. Further, other plastics that can be used contain a polycarbonate resin, acryl resin, ABS, polyacetate, PVA and rubbers. This is also applicable to the metals and glasses. The configuration of the present invention is valid when an image is to be formed on the PET film, OPS film, OPP film, ONy film and PVC film that can be shrunk especially by heat, out of the aforementioned recording mediums. These substrates tend to be curled and deformed by the heat generated by the curing and shrinkage of ink and in the process of curing reaction. Not only that, ink film cannot conform to the shrinkage of the substrate.

In the present invention, use of a longer recording medium (web) is more effective when consideration is given to packaging costs, production costs, recording medium costs, print creation efficiency and compatibility with variously sized prints.

### EXAMPLES

The following describes the present invention with reference to embodiments, without the present invention being restricted thereto:

<<Preparation of Pigment Dispersant>>

After various compositions given in table had been dispersed for one hour using a sand mill, they were filtrated by a 25 μm filter, whereby pigment dispersants 1 through 9 were obtained. The amount added is expressed in terms of “part(s) by mass”.

TABLE 1

| | | | | | | Polymerized |
|---|---|---|---|---|---|---|
| | Pigment | | | Dispersant | | monomer |
| | | | Amount | | Amount | OXT-221 |
| No. | Name | pH | added | Name | added | (*7) |
| Pigment | MA7(*1) | 3 | 21.4 | PB822 | 8.6 | 70.0 |
| dispersant 1 | | | | (*5) | | |
| Pigment | MA11(*2) | 4 | 21.4 | PB822 | 8.6 | 70.0 |
| dispersant 2 | | | | | | |
| Pigment | #44(*3) | 8 | 21.4 | PB822 | 8.6 | 70.0 |
| dispersant 3 | | | | | | |
| Pigment | #4000(*4) | 10 | 21.4 | PB822 | 8.6 | 70.0 |
| dispersant 4 | | | | | | |
| Pigment | #44 | 8 | 21.4 | PA111 | 8.6 | 70.0 |
| dispersant 5 | | | | (*6) | | |
| Pigment | #44 | 8 | 27.3 | PB822 | 2.7 | 70.0 |
| dispersant 6 | | | | | | |
| Pigment | #44 | 8 | 25.0 | PB822 | 5.0 | 70.0 |
| dispersant 7 | | | | | | |
| Pigment | #44 | 8 | 15.0 | PB822 | 15.0 | 70.0 |
| dispersant 8 | | | | | | |
| Pigment | #44 | 8 | 13.6 | PB822 | 16.4 | 70.0 |
| dispersant 9 | | | | | | |

(*1)Carbon black by Mitsubishi Chemical Industries, Ltd.
(*2)Carbon black by Mitsubishi Chemical Industries, Ltd.
(*3)Carbon black by Mitsubishi Chemical Industries, Ltd.
(*4)Carbon black by Mitsubishi Chemical Industries, Ltd.
(*5)Polymeric dispersant having a basic anchor, Ajisper PB-B22 by Ajinomoto Fine Techno
(*6)Polymeric dispersant having an acid anchor, Ajisper PA-111 by Ajinomoto Fine Techno
(*7)Oxetane compound by Toagosei Co., Ltd.

<<Ink Preparation>>

Inks 1 through 18 were prepared in conformity to the composition shown in Table 2, using the pigment dispersant prepared in the above-mentioned step.

These inks were mixed with all additives except for the pigment dispersant, and a check was made to see that they were dissolved sufficiently. Then the liquid temperature was increased to 50° C. and the above-mentioned pigment dispersant was added little by little. After the liquid was sufficiently agitated by a dissolver, it was cleared by a 0.8 μm filter. In the process of the pre-treatment, pre-filtering was conducted by a 10 μm filter. In the aforementioned filtering process, there was little pressure loss, and a sufficient filtering speed was achieved. Ink was prepared at an ambient temperature of 20° C. with relative humidity of 30 percent.

TABLE 2

| | Ink prescription | | | | | | | | | |
|---|---|---|---|---|---|---|---|---|---|---|
| | | | | | | | Basic | | | |
| | Pigment | | Polymerized | | | | compound | | | |
| | dispersant | | monomer | | | Initiator | N-ethyl | | | |
| | | Amount | | 2021P | | SP-152 | diethanol | Water | Dispersant/ | |
| No. | Name | added | OXT-221 | (*8) | Water | (*9) | amine | content % | pigment | Remarks |
| 1 | **1 1 | 18.7 | 47.6 | 26.8 | 1.8 | 5.0 | 0.10 | 2.0 | 0.4 | Comp. |
| 2 | **1 2 | 18.7 | 47.6 | 26.8 | 1.8 | 5.0 | 0.10 | 2.0 | 0.4 | Inv. |
| 3 | **1 3 | 18.7 | 47.6 | 26.8 | 1.8 | 5.0 | 0.10 | 2.0 | 0.4 | Inv. |
| 4 | **1 4 | 18.7 | 47.6 | 26.8 | 1.8 | 5.0 | 0.10 | 2.0 | 0.4 | Inv. |
| 5 | **1 3 | 18.7 | 48.6 | 26.8 | 0.8 | 5.0 | 0.10 | 1.0 | 0.4 | Comp. |
| 6 | **1 3 | 18.7 | 48.1 | 26.8 | 1.3 | 5.0 | 0.10 | 1.5 | 0.4 | Inv. |
| 7 | **1 3 | 18.7 | 44.6 | 26.8 | 4.8 | 5.0 | 0.10 | 5.0 | 0.4 | Inv. |
| 8 | **1 3 | 18.7 | 44.1 | 26.8 | 5.3 | 5.0 | 0.10 | 5.5 | 0.4 | Comp. |
| 9 | **1 5 | 18.7 | 47.6 | 26.8 | 1.8 | 5.0 | 0.10 | 2.0 | 0.4 | Inv. |
| 10 | **1 6 | 18.7 | 47.3 | 27.2 | 1.8 | 5.0 | 0.10 | 2.0 | 0.1 | Inv. |
| 11 | **1 7 | 18.7 | 47.4 | 27.1 | 1.8 | 5.0 | 0.10 | 2.0 | 0.2 | Inv. |
| 12 | **1 8 | 18.7 | 48.3 | 26.1 | 1.8 | 5.0 | 0.10 | 2.0 | 1.0 | Inv. |
| 13 | **1 9 | 18.7 | 48.6 | 25.9 | 1.8 | 5.0 | 0.10 | 2.0 | 1.2 | Inv. |
| 14 | **1 3 | 18.7 | 47.7 | 26.8 | 1.8 | 5.0 | 0.00 | 2.0 | 0.4 | Inv. |
| 15 | **1 3 | 18.7 | 47.7 | 26.8 | 1.8 | 5.0 | 0.05 | 2.0 | 0.4 | Inv. |
| 16 | **1 3 | 18.7 | 46.7 | 26.8 | 1.8 | 5.0 | 1.00 | 2.0 | 0.4 | Inv. |
| 17 | **1 3 | 18.7 | 42.7 | 26.8 | 1.8 | 5.0 | 5.00 | 2.0 | 0.4 | Inv. |
| 18 | **1 3 | 18.7 | 41.7 | 26.8 | 1.8 | 5.0 | 6.00 | 2.0 | 0.4 | Inv. |

**1: Pigment dispersant
Comp.: Comparative example
Inv.: Present invention
(*8) Epoxy compound and seroxide by Daicel Chemical Industries, Ltd.
(*9) Initiator, Adecaoptomer by Asahi Denka Kogyo K. K.

<<Checking the Ink Storage Stability>>

Ink prepared in conformity to the aforementioned steps was sealed up in a glass vessel at an ambient temperature of 20° C. with relative humidity of 30 percent. Then it was stored for one week at a temperature of 60° C. The viscosity and mean particle size before and after storage were checked.

The viscosity was measured by a viscosity measuring apparatus MCR300 (by Physica Inc.) (Shear rate: 11.7 (1/s)). The mean particle size was measured using a particle size distribution gauge, Zetasizer Nano 90s manufactured by Marburn Inc.

Table 4 shows the results of these measurements:

<<Inkjet Image Output>>

Recording was carried out on a recording medium (PET film) for each of the inks by means of an inkjet recording apparatus using an piezo type inkjet nozzle with 128 nozzles having a diameter of 23 μm.

The ink feed system used contains an ink tank, feed pipe, front chamber ink tank immediately before the head, filter-equipped pipe and piezo head. The portions from the front chamber to the head portion were heat-insulated and heated. The ink feed system was designed in an enclosed structure. Each temperature sensor is located in the front chamber and close to the nozzle. The temperature was controlled in such a way that the nozzle was kept at 55±2° C. The ink particle was about 7 μl in size. Drive was performed at a drive frequency of 10 kHz so that ink could be emitted at a resolution of 720×720 dpi (“dpi” refers to the number of dots per 2.54 cm).

Light was applied 0.2 sec. after ink had reached the recording medium. A metal halide lamp having a peak wavelength of 365 nm (MAL 400 NL by Japan Storage Battery Co., Ltd.) was used as a light source, and the illuminance on the exposed surface was 650 mW/cm². Further, the recording medium having just reached by ink was heated by the conveyance guide plate so that the recording medium surface would be 40° C.

Under these conditions, printing was performed on PET film, and the following evaluation was made. The result of the evaluation is given in Table 3.

[Mixing of Colors (Bleeding)]

A magnifier was used to magnify the adjacent color dots in the printed high-definition image, and the manner of bleeding was visually evaluated.

A . . . Roundness of adjacent dots is maintained, without bleeding of ink.

B . . . Almost round shapes of adjacent dots are maintained, and there is almost no bleeding.

C . . . There is a slight bleeding of adjacent dots, and the dots are slightly deformed, with the usable level barely maintained.

D . . . Adjacent dots are mixed with each other by bleeding, without the usable level maintained.

TABLE 3

| | Ink storage stability | | | | |
|---|---|---|---|---|---|
| | Viscosity | | Mean particle | | |
| | (*1) (cP) | | size (*2) (nm) | | Mixing of |
| Ink | Before | After | Before | After | colors |
| No. | storage | storage | storage | storage | (bleeding) |
| 1 | 40 | 100 | 100 | 100 | A |
| 2 | 40 | 50 | 100 | 100 | A |
| 3 | 40 | 45 | 100 | 100 | A |
| 4 | 40 | 40 | 100 | 100 | B |
| 5 | 40 | 80 | 100 | 100 | A |
| 6 | 40 | 45 | 100 | 100 | A |
| 7 | 40 | 40 | 100 | 100 | C |
| 8 | 40 | 40 | 100 | 100 | D |
| 9 | 50 | 60 | 130 | 140 | B |
| 10 | 40 | 50 | 100 | 110 | A |
| 11 | 40 | 45 | 100 | 105 | A |
| 12 | 45 | 45 | 110 | 110 | B |
| 13 | 50 | 50 | 115 | 115 | C |
| 14 | 40 | 50 | 100 | 100 | A |
| 15 | 40 | 45 | 100 | 100 | A |
| 16 | 40 | 40 | 100 | 100 | A |
| 17 | 40 | 40 | 100 | 100 | B |
| 18 | 40 | 40 | 100 | 100 | C |

(*1): Measured by a viscosity measuring apparatus MCR300(by Physica Inc.) (Shear rate: 11.7 (1/s)).
(*2): Measured by a particle size distribution gauge, Zetasizer Nano 90s (by Marburn Inc.)

The ink of the present invention is characterized by a small variation in the viscosity and mean particle size before and after storage (excellent storage stability). Further, result of the color mixing (bleeding) test is satisfactory.

1. An inkjet recording ink which is activated light cure ink, containing cation polymerized monomer, initiator and pigment, wherein the moisture content for measurement by the Karl-Fischer method is 1.50 through 5.00 percent by mass and the pH value of the pigment is 4 through 10.

2. The inkjet recording ink of claim 1, further containing pigment dispersant, wherein the pigment is dispersed by a pigment dispersant comprising a basic anchor portion.

3. The inkjet recording ink of claim 2, wherein the ratio of the pigment dispersant to the pigment is 0.2 through 1.0.

4. The inkjet recording ink of claim 2, further containing a basic compound.

5. The inkjet recording ink of claim 1, wherein the cation polymerized monomer is an oxetane compound.

6. The inkjet recording ink of claim 1, wherein the cation polymerized monomer is a compound provided with oxirane ring.
